(19) United States
(12) Patent Application Publication
(10) Pub. No.: US 2004/0153675 A1
(43) Pub. Date: Aug. 5, 2004

(54) Procedure for user login to data processing devices

(76) Inventors: Karlheinz Dorn, Kalchreuth (DE); Ivan Murphy, Baiersdorf (DE); Thomas Pohley, Erlangen (DE); Andreas Schuelke, Herzogenaurach (DE)

Correspondence Address: SCHIFF HARDIN & WAITE, Patent Department, 6600 Sears Tower, 233 South Wacker Drive, Chicago, IL, 60606, US

(21) Appl. No.: 10/725,110

(22) Filed: Dec. 1, 2003

Related U.S. Application Data
(60) Provisional application No. 60/430,206, filed on Dec. 2, 2002.

(30) Foreign Application Priority Data
Nov. 29, 2002 (DE) 10256078.1

(51) Int. Cl. H04L 9/32

(52) U.S. Cl. 713/202

(57) ABSTRACT

The invention concerns a procedure for logging a user into a data processing device with an operating system and a data processing program. In a first step, data for authenticating a user is entered, in a second step an identity and access rights are determined based upon the authentication data and in a third step access is provided for the application program and/or for sensitive data based on the defined access rights. In accordance with the invention, the steps are independent from starting the operating system or the data processing applications. In an especially advantageous version of the invention, a user switch can be performed by logging a user out and logging another user in while retaining the application context, i.e., user interface and current processing data.

### CROSS-REFERENCES TO RELATED APPLICATIONS

This application claims the benefit of U.S. Provisional Application No. 60/430,206, filed Dec. 2, 2002, herein incorporated by reference.

### BACKGROUND OF THE INVENTION

The invention concerns a procedure for quickly switching users on data processing devices.

Processing electronic data using data processing devices in working environments with sensitive data requires effective data protection against unauthorized access. Exclusive access to patient's records or pictures from digital diagnostic imaging systems, for example, must be guaranteed to authorized personnel. In addition, all access to sensitive data and any changes made in a medical working environment must be logged so that the person that made the access and the type of access is traceable at any time.

On standard data storage devices, such as patient records on paper or diagnostic images in file systems, control of access to the data is possible by controlling the whereabouts of the data storage device, whereas electronic data is, of course, much more accessible, and instead of moving the data, access to that data must be controlled. For this purpose, users of data processing systems for sensitive data such as medical computer work-stations must be identified on the system by way of entering a name and a password or with biometric identification such as finger printing or chip cards etc. During this authentication process, the identity of the respective user is determined for record keeping purposes and the data and user access is authorized for the purposes that apply to the respective user.

The range of access possibilities is also defined in hardware and software.

During a standard day in clinical practice, there are normally several people, e.g., doctors or medical/technical assistants, who work on the same computer terminal for analyzing or creating diagnostic images, for example. To satisfy the demands for a rational and economic working environment, switching users must be able to be performed as quickly as possible. If work is to be continued on the same data processing device or the same patient file, it must also be made available as quickly as possible after switching users.

Previously, user authentication was performed on the operating system level of the data processing device. The “Login” on the operating system is identified at system start-up with the entry of a user name and password and the operating system assigns access rights for data, hardware and software based upon this identification. This authentication on the operating system (e.g., Microsoft Windows®) level has the distinct disadvantage that in order to switch users, all access to the patient data must be ended, all applications must be stopped and the operating system may have to be ended and restarted again. These procedures all take time. In addition, portions of working environment and patient data are not available if they have been lost from temporary memory when a user logs of or terminates execution of the operating system.

To solve this problem, work groups having the same rights for all members of the group were created for authentication on the operating system level. The authentication of users in group accounts also carries with it the disadvantage that determining the user that is currently working is not possible by the data processing device or the application that is being used. Since this would make logging the data-user's actions impossible, switching users that are within a user group occurs by one user ending the running application and the next user having to restart it again. Temporary data still gets lost in ending the application instead of the operating system, but the time loss is much less.

Before a new user is registered on the system, the current application data is either stored or thrown out. Therefore, while the user is logging off or when switching users, if this data is stored, no data is lost.

The aspect of economical work habits for time saving quite often leads to users not being authenticated when using medical magnetic resonance imaging data processing devices. Instead, the only identification and authorization for users is purely physical control of the access to the medical magnetic resonance imaging device, i.e., simple access control for the room in which the device is located. In particular, logging or recording the data access by users is only indirectly possible with this type of device by e.g., matching the time of the data access with the person that was in the room at the time. This type of logging process takes more time and data cannot be reconstructed in the long-term.

The described disadvantages mainly occur in a medical working environment where there time is already a major factor and can become even more of a factor in an emergency. However, it also affects other data processing devices which handle sensitive data, e.g., accounting systems, research and development, insurance or when processing demographic queries.

### SUMMARY OF THE INVENTION

The purpose of the invention is to fashion a procedure to quickly switch users of data processing devices that deal with sensitive data and on which the authentication of the user is necessary. Sensitive data, in the embodiments described below, applies especially to personal information concerning health or financial status or in any other information that relates to personal rights.

This purpose is met by a method for logging a new user into a data processing device with an operating system and an application program, comprising the sequential steps of: in a first step, determining authentication data for authenticating a user; defining an identity and access rights depending on the authentication data; and providing access, depending on the defined access rights, for at least one of the application program and sensitive data; the method being independent of restarting the operating system or the application program.

An objective of the invention is to handle the authentication of users on data processing devices using an authentication instance that works independent of the login to an operating system or the running application. Independent, in this case, means that the user login does not mean that the user can login without having to restart the operating system or the application. Authenticating means the identification of a person and the assignment of access rights for data, software and hardware for this person. The authentication instance enables users to switch, i.e., re-authenticate, while the operating system and the application or applications are still running.

On one hand, this allows users to switch quickly because the time that was required for restarting the application or the system is saved and on the other hand, the new user will be able to continue to use all of the data that is being temporarily stored such as the current patient data or the current constellation of the application or applications, since this will not be lost in the restart.

Switching users is also fast enough to be used on data processing devices for which time is a major factor. This enables user identities to be determined at all times and this can be used to create a complete log for recording all user access.

An advantageous embodiment of the invention enables the authentication instance to perform the user switch without losing any temporary data such as current patient data, current application settings or views depending upon the definitions made by a user desiring this. Data as well as the overall application context is retained. By retaining the current status, different users can work with the same data in the same application context in quick succession. At the same time, the re-authentication when users are switched guarantees that the user always has enough access rights to continue working with the same data.

In another advantageous version of the invention, every user action is logged with information concerning the identity. The user identity to be used for the logging procedure is defined by the authentication instance which also defines the identification and the authentication at the same time. This, therefore, can guarantee that all data access is logged with information on the identity of the current user since the authentication instance does not authorize data access without defining a user identity.

In another advantageous version of the invention, the authentication instance enables users to switch and delete the current status of the processed data and the user interface at the same time, i.e., the current screen views.

The deletion concerns temporary data only and all stored data is retained. Switching users combined with a deletion of the current status may be performed with a respective entry made by the current user. It allows the user to log out of editing data and the current application without having to end the application or the operating system.

This allows the user to end work on the data processing device without the following user having to restart the application or the operating system. This saves the new user the time that would have been taken up with the restart, since that user can simply carry on with the running application as soon as the authentication is complete.

In another advantageous embodiment of the invention, the user switch is made when a certain condition is met, e.g., a certain amount of time has elapsed, initiated automatically analogously to the screen saver. At the same time, just as with a screen saver, the current application data is deleted temporarily, i.e., made unrecognizable but retained in the system. By executing an action in the data processing device with the activated screen saver instance, e.g., key press or a movement of the mouse, a request for authentication of the current user is generated. If this authentication determines that the user has not been switched then the previous display status and the temporary data status is recreated and work can be continued. If, on the other hand, the authentication determines that another user with less access rights wants to work on the device, then the previous display status and the temporary data status are deleted or reduced in content by the amount that is not covered by the respective access rights. Temporary application data is lost with the reduction.

However, if the authentication determines that the new user has more extensive access rights, then, depending on the parameters that are set, either the previous display status and data status can be retained or the contents of these states can be reduced.

The functionality combined with a screen saver increases the security of the system where sensitive data is concerned since the device, e.g., in cases where the user must end work unexpectedly and without logging out, automatically blocks any access and requests authentication again.

In another advantageous embodiment of the invention, the authentication instance automatically blocks the system at the operating system level upon recognition of an incorrect identity or password of a user, e.g., exits from the operating system. This increases the security of the sensitive data being processed by the device since the incorrect entry leads to a system status that offers maximum access security. Any possibility of manipulating the authentication instance through weak points that were made available by the operating system is out of the question. Blocking data access on the operating system level is the strongest barrier against manipulation attempts.

The invention further covers a computer program that is configured to run on a data processing device to run the inventive method, and also covers a data storage media having such a program stored on it.

### DESCRIPTION OF THE DRAWINGS

To follow are application embodiments of the invention illustrated with figures.

FIG. 1 is a block diagram illustrating the system architecture with an authentication instance;

FIG. 2 is a flowchart of the authentication process;

FIG. 3 is a state diagram of system states at login and logout;

FIG. 4 is a state diagram of system states when switching users; and

FIG. 5 is a state diagram of system states for various user actions.

### DETAILED DESCRIPTION OF THE PREFERRED EMBODIMENTS

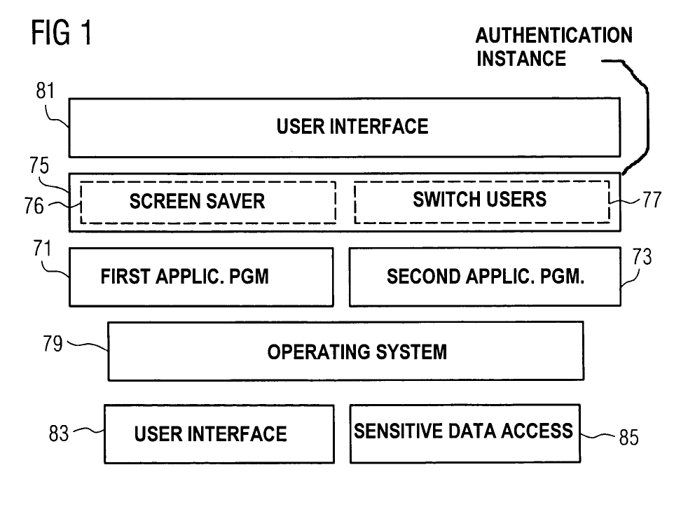

FIG. 1 shows a schematic view of a system architecture in an embodiment of the invention for running the process. FIG. 1 shows the functional instances of the architecture without any direct reference to system or device representations of this instance, e.g., with certain hardware components.

A first application program 71 and a second application program 73 for processing sensitive data are shown. Sensitive data can be, e.g., medical records, diagnostic image files, financial information or insurance data or demographic data. The data should be characterized as being sensitive by being, at least partially, confidential and accessible by certain users with respective rights only.

Application programs 71 and 73 can be, e.g., magnetic resonance images for medical diagnosis, analysis programs for electronic patient data, programs for financial transactions, statistical evaluations or accounting. A user can use application programs 71, 73 to view, change, create or delete data. In processing the data, other application programs can also be started or application programs 71, 73 can be ended. It makes no difference whether only one or more of application programs 71, 73 are started. It is only important that they can communicate with the authentication instance 75 described below, using a common interface as is similar to a screen saver interface.

The application programs 71, 73 are secured by authentication instance 75, which controls all access. The authentication instance 75 determines the identity of the user either by requesting the user name and password or by accessing a biometric measurement device, e.g., to analyze a finger print or iris conformation or a chip, transponder, reader device.

Depending on the identity that is determined, the authentication instance 75 assigns the user with access rights for data, software and hardware. The user can use everything that is granted with the access rights from the operating system 79; the operating system assigns the maximum possible access rights. This includes access to data 87, hardware 85 and software 71, 73 so that the authentication instance 75 can be used to enable or block the use of all of the resources of the device including those of the application programs 71, 73.

The authentication instance 75 works within the scope defined by the operating system 79 and only if the operating system 79 has been started. It operates within that defined scope, but works independent of the operating system 79 and, in particular, independent of restarting the operating system 79. User access is performed exclusively through the user interface 81, which is controlled by the authentication instance 75.

The authentication instance 75 may, e.g., assign two sub-instances, one screen saver instance 76 and one instance for switching users 77. The screen saver instance 76 ensures that the user interface 81 is deleted when a certain condition is met, e.g., after a certain amount of time has elapsed. “Deleted”, in this case, means that the image displayed on user interface 81 on a display device, e.g., a monitor, is changed so that no confidential data can be displayed; the contents are either reduced or neutralized. This should prevent sensitive data from being seen if the previous user must leave unexpectedly and without logging out.

The screen saver instance 76 can be, as is known for screen savers, activated after a certain amount of time has elapsed with no user entry made on the device. However, to increase the security of the data, the screen saver instance 76 can also be activated independent of user entry.

In order to deactivate the screen saver instance 76 and to return to the previous user interface 81, the user must be identified again, as described above. The display of the user interface 81 after deactivation depends on whether the users have been switched and, in some cases, whether the access rights are different for the new user. The contents can remain the same, or they can be changed.

If the users were not switched and the previous user is authenticated again, then the user interface 81 is displayed exactly the same after the screen saver instance 76 is deactivated and the overall application context is retained. This also includes the status of the running applications, e.g., which windows were open and which application modules were loaded as well as the currently displayed sensitive data and the respective temporary processing status. Temporary changes to the data that have not yet been saved are also retained and can be stored or used for further processing.

However, if users have switched and the authentication determines that the new user has more restricted access than the previous user, then the content of the user interface 81 is reduced according to the scope of the restrictions corresponding with that user's access rights or it is completely neutralized and the application context is only kept within defined restrictions.

If the new user does not have the rights to access the data that was previously displayed, then this data is removed from the user interface 81 and is no longer accessible through application programs 71, 73. If the new user only has viewing rights and is not permitted to make changes, for example, then any possible data-change modules that are blocked in application programs 71, 73 are removed from user interface 81 or the applications that are purely for changing data are closed.

However, if the new user has more rights than the previous user, depending on the previously defined settings, the previous application context including the user interface 81 with all data can be displayed again completely or another status can be defined, e.g., an expanded range of sensitive data or function modules can be made available from application programs 71, 73.

The user switch instance 77 is activated depending on the screen saver instance 76 which when deactivated requests a new authentication on one hand and, on the other, the user switch instance 76 can be activated by the user. It is activated when, for example, the user logs out of the device with a corresponding entry. Logging out causes all currently displayed data to be removed from the user interface 81 and from the application programs 71, 73, whereby all temporary information such as tentative data changes or the current status of the application programs 71, 73 are immediately made unavailable. Depending on the parameters that have been defined, the temporary data can either be deleted completely or saved automatically. The application programs 71, 73 that are running are set to a neutral output status in which the new user can begin working.

The respective user entry can also activate the user switch instance 77 so that the current user is logged out, but all temporary data will remain available on the user interface 81. This possibility makes sense if the new user is to continue working with the currently displayed data in the current status of the application programs 71, 73. This type of switch allows the authorization of access rights to remain the same while the identity of the user is changed. The respective user identity is then active for logging all user actions and access.

If the user switch instance 77 determines that the new user has fewer access rights during the authentication so that temporary data is no longer allowed to be shown on the user interface 81 and would be lost, then a corresponding warning message can be generated for that user, e.g., in a respective notice box on the user interface 81. This allows the previous user to recall the temporary status of the data and program views and save these in the device if required by logging in again. If this is not desired, the warning message can be confirmed and a new application status with a changed user interface 81 can be generated, taking the loss of temporary data into account.

The selected drawing in FIG. 1 shows that authentication instance 75 puts the entire user interface 81 on the application programs 71, 73 and running operating system 79. This is especially important for the procedure, since access control takes place on a level above the operating system level 79 and the application program level 71, 73. Therefore, changes to the user authorization and identification can be made without having to restart the running application programs 71, 73 or the operating system 79. This greatly increases the speed of the authentication process for switching users.

The ability to quickly switch users makes this procedure practical on devices where time is a major factor, e.g., in the medical or emergency medical branches. The utilization of this procedure enables the logging and tracing of all user actions. This kind of logging is especially mandatory for the privacy of personal data in health care. Another advantage is that work stations that are protected using screen savers can no longer be blocked because a new user does not know the standard password or the password of a previous user for the screen saver. Instead, the screen saver instance 76 is deactivated when a new user is authenticated whereby he/she must provide his/her own identification data.

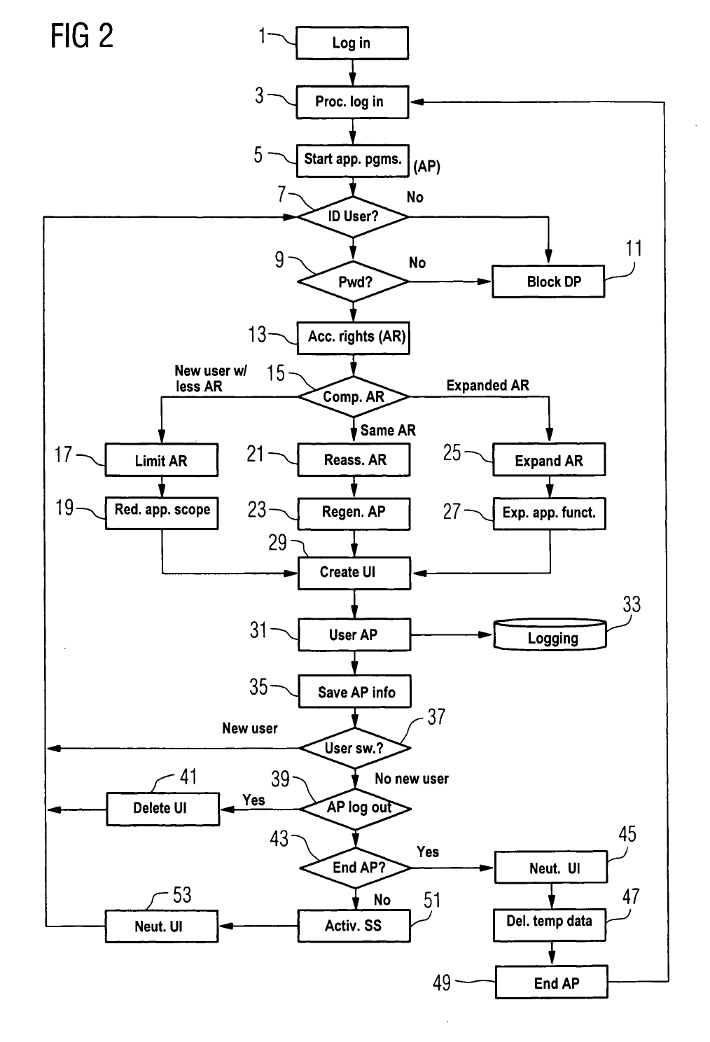

In FIG. 2, the steps for the procedure are shown in a flowchart. Step 1 is the log in to the operating system which works in step 3 in one of the operating system configurations that is defined through the login procedure. The access rights that are assigned during the operating system login procedure are defined so that the control of all access can be guaranteed through the authentication instance 77. Logging into the operating system 79 with all access rights remains under the control of the system administrator while application users will be provided with access rights through the authentication instance 77.

In step 5, the application programs 71, 73 are started. Since the use of application programs 71, 73 is already subject to the terms and restrictions of access rights, the entry of a user login is required in step 7 immediately after starting the application program 71, 73.

This entry can be made, as described above, manually by entering the respective data or biometric data or other information through a corresponding measuring device. It can be made through a login window similar to the login procedure for the operating system on the user interface 81 or in a notice window on the user interface 81 called up by the user.

If the user login cannot be identified, then the data processing device will be blocked for further entries in step 11. Otherwise, a user password is requested in step 9, whereby the use of biometric data or a chip card are combined in steps 7 and 9. If the user password in step 9 cannot be verified, then all access is blocked in step 11 again. Access is blocked in step 11 so that further access is only possible for the system administrator, or the system will shut down to prevent any further manipulation attempts. The blocking procedure 11 can simply consist of a new login and password procedure being generated as well however.

If the login and password can be verified successfully, then the identity of the user is defined and the definition of the access rights is performed in the device in step 13. This includes or excludes the rights for using the application programs 71, 73 as well as the hardware and the access to sensitive data 85.

In the following step 15, the assigned rights are compared with the previous rights on the device to find any changes between the previous user and the new user.

If there is a new user with less rights than the previous user, then the data access is limited in step 17 and, in the following step 19, the available scope of application programs 71, 73 or the application modules is also reduced.

If the rights have not changed, e.g. because the same user logged in again or a new user having the same access rights or working in the same role logged in then the data access rights are all reassigned in step 21 and in step 23, the functionality of the application programs 71, 73 including the previous application context is regenerated as well.

If the scope of access has been expanded which can be the case, e.g. if no user was logged in previously, then the data access rights are expanded in step 25 and in step 27 an expanded range of functionality is enabled for the application program 71, 73.

Based on the rights that have been assigned, the user interface 81 is created in step 29 and is displayed on a display device, e.g. a computer monitor. In this case, only data that the user has rights for is displayed and only function modules of application programs 71, 73 that the user is permitted to use are made available. If the user has, e.g., no rights for changing data, then the modules for changing data in application programs 71, 73 are deactivated.

In the following step, the user works with 31 the respective application program 71, 73 whereby all of the actions and data access are logged along with the defined identity in a log 33 so that the reconstruction of all user activity is possible at any time in the future.

In the following step 35, the user is able to save the current data or the current status of the application program 71, 73.

In the following step 37, a user switch can be initiated. Step 37 can be generated by a respective user entry, for example. During the user switch 37, the present status of the user interface 81 is retained (frozen) and a new authentication process for a new user is started in step 7 described previously. This starts the procedure with step 7 along with the ability to retain the application context.

Otherwise, in step 39, the user can log out of the application program 71, 73. In this case, the user interface 81 is deleted in step 41. This deletes all of the data that was displayed 85 and the application programs 71, 73 are put into a neutral status. Then, a new user can login as described in step 7.

Otherwise, in step 43, the application programs 71, 73 can be ended. In this case, the user interface 81 is brought into a neutral status in step 45, in which no data is displayed and in step 47 all temporary data is deleted and then in step 49, the application programs 71, 73 are ended. After the application programs 71, 73 have been ended, only the operating system 79 is left running in step 3, whereby the access rights based on the start-up login procedure for the operating system 79 in step 1 are limited so that no further manipulation is possible.

If certain conditions occur, e.g., a defined amount of time has elapsed, the screen saver instance 76 can be activated in step 51 to run similar to that of a standard screen saver.

This causes the user interface 83 to be put into a neutral status in the following step 53 so that no data 85 can be displayed. The previous status of the data and the user interface 81 is stored in temporary memory however in order to make it available again after deactivating the screen saver instance. From this status, the screen saver instance 76 can only be deactivated by executing the login procedure described in step 7 again. However, this is unlike a standard screen saver in that a standard screen saver would be deactivated by a standard screen saver password which may be defined by the previous user and may not be known by the every user.

The flow-chart shown in FIG. 2 shows clearly that the user login and switching users occurs without having to restart the application programs 71, 73 or the operating system 79. Authentication and re-authentication are instead performed via the authentication instance 75 while the application programs 71, 73 and the operating system 79 are running and therefore require very little time. At the same time, data is protected according to the data protection regulations and actions are logged continuously. Because of the quickness, the procedure can also be used on systems where time is a major factor and enables continuous logging of current entries supplemented with user identity.

The procedure can be utilized on a data processing device. It can be made as a computer program that can be executed on a data processing device to run the procedure on that device. It can be stored as a program on a data storage device or another data storage medium to work alternating with a data processing device so that the procedure can run on the device.

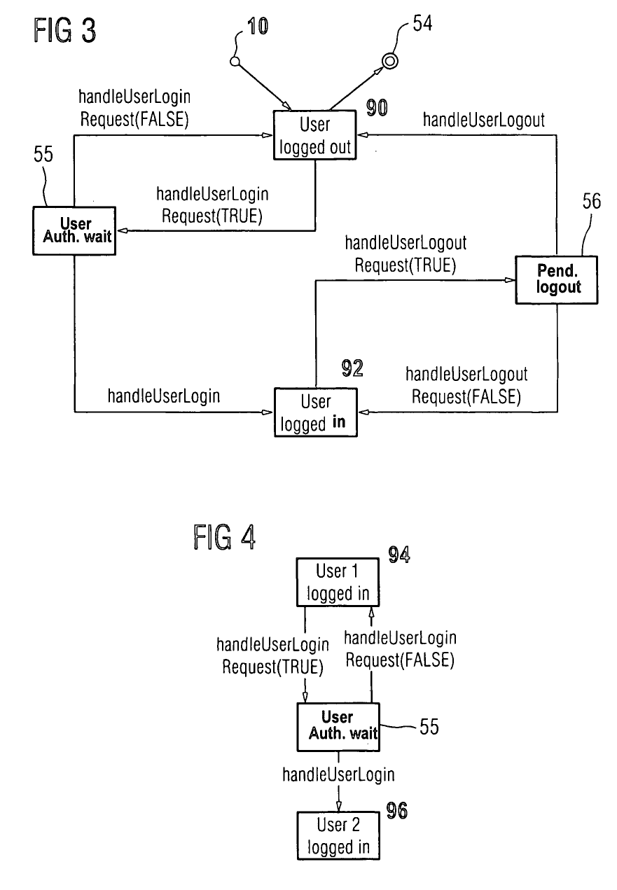

In the following, FIGS. 3, 4, 5 and 6 are used to describe how, in an embodiment of the invention, the user is given the opportunity to abort the logging out procedure or the procedure of switching users in order to return to the application programs. This may be done in an embodiment, e.g., by sending a polling called handleUserLoginRequest or handleUserLogoutRequest from a control program named the Component Manager to all running application programs, whereby this request can produce a positive or negative result—TRUE or FALSE therefore. If an application program disagrees to the user switch being performed (since, e.g., the previous user has not yet saved data), then the new user is informed that the data of the previous user can be lost if the login procedure is continued.

If the user decides to abort the login procedure, then the application program is informed (handleUserLoginRequest (FALSE) generated) and the data of the previous user remains loaded. If the user decides to continue with the login procedure then the application programs must unload the data of the previous user using the methods defined for the handleUserLogin. If an application program disagrees to the logout procedure (because e.g. the user has not yet saved data), then the user is informed that the data can be lost if the logout procedure is continued. If the user decides to abort the logout procedure then the application programs are informed (handleUserLogoutRequest (FALSE) generated) and the data is retained. If the user then decides to continue the logout procedure, the application programs must unload their data in the method handleUserLogin without saving first. If all application programs are in accordance, then they are informed that the user switch or the user logout is complete via a callback method defined for this purpose and which is designated as handleUserLogin or handleUserLogout.

In FIG. 3, the system states are shown for logging a user in and out. The beginning state is achieved by loading the operating system 10. This achieves a status of the system in which no user is logged in or all users of the device are logged out which is shown in FIG. 3 by the box labeled “User logged out” 90. A user logs into the device with a UserLoginRequest being sent to the system in a login request. The login request is processed by a program component that is responsible for the task and is called a handleUserLoginRequest. If a user is authenticated successfully, it is confirmed by the indicated program component by returning a positive value which is shown in FIG. 3 as a handleUserLoginRequest (TRUE). Otherwise the program component returns a negative value, which is shown in FIG. 3 as a handleUserLoginRequest (FALSE).

If the login request leads to the successful authentication of a user, a system status 55 is achieved within which the user login exists. Another program component then runs the user login through the system. This component is shown in FIG. 3 as handleUserLogin. After the login is successful, the system is found in a state that is labeled as User Logged In 92. The user that is logged in can now work within the limitations of the assigned access rights.

If the user wants to log out of the system, it is done with a logout request LogoutRequest. The logout request is handled by a program component that is responsible for this task and is labeled handleUserLogoutRequest in FIG. 3.

In certain conditions, e.g., if the system could not yet complete all of the user's processes, the indicated program component will deliver a negative value which is shown as a handleUserLogoutRequest (FALSE) in FIG. 3. The user logout can be delayed in this case until the system has successfully ended all of the processes that were started. Otherwise, a positive value is returned, shown in the figure as handleUserLogoutRequest (TRUE), and the system is put into a pending status 56. From this status 56, a program component, shown in FIG. 3 as HandleUserLogout, runs the logout procedure.

After the user is logged out successfully, the system is again found in a status in which all users are logged out, shown as User Logged Out 90, and from which a user can login or the system can be shut down in the end point 54.

In FIG. 4, the system states for switching users are shown. The beginning is shown with the system in a status where user 1 is logged in, shown in FIG. 4 as User 1 logged in 94. In this status, user 2 can call up another login request. The program component for this which was described previously, handleUserLoginRequest, processes the request from user 2. If the program component determines that user 2 can log in, then the respective positive response, shown as handleUserLoginRequest (TRUE), puts the system into status 55 in which the login for user 2 exists. Otherwise, the program component delivers a negative response, shown as handleUserLoginRequest (FALSE) and user 1 remains logged in.

This can be, for example, if user 1 is still working on active processes in the system.

In status 55, in which the login for user 2 is held, all of the required steps are then processed so that a program component, shown as HandleUserLogin, can then perform the login procedure for user 2. User 2 is then logged into the system which is shown in FIG. 4 as User 2 Logged In 96.

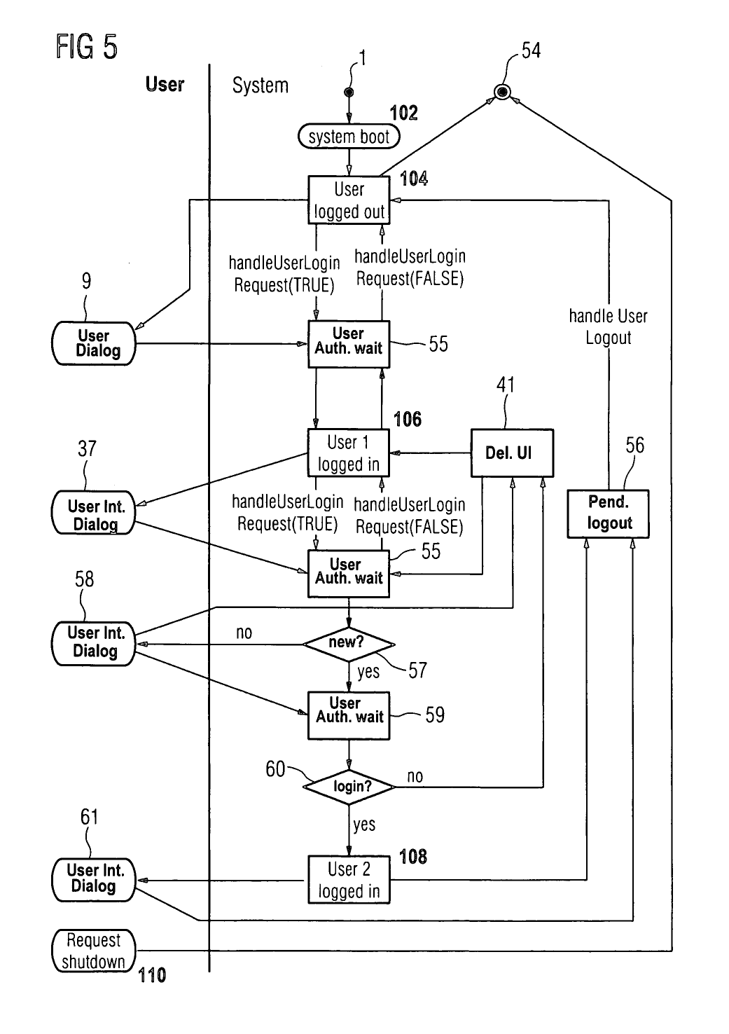

In FIG. 5, the system states and user actions are shown for switching users and logging in and out. FIG. 5 shows elements on the user interface under the heading “User” on the left and separated by a vertical line, the procedures within the system under the heading “System” on the right.

Starting with point 1, the operating-system is loaded, shown in FIG. 5 with “system boot” 102. The system is then in a status in which all users are neither logged in nor definitively out, which is shown with User Logged Out 104. A user dialog 9 then enables the user to perform a login procedure. Within the system, the program component HandleUserLoginRequest, described above, is started. A failed attempt to login is met with a negative response from this program component, shown with HandleUserLoginRequest (FALSE) and leads back to a system status with no user logged in 104. A successful authentication leads to a positive response which is shown as HandleUserLoginRequest (TRUE) and puts the system into status 55, in which the login is held for the user, user authenticated. The user login is processed so that the user is logged in, which is shown in the next step as User1 logged in 106.

In the system status with user 1 logged in, a user switch can be requested through the user interface dialog 37. Within the system, this request is processed by the responsible program component and either leads to a result of HandleUserLoginRequest (TRUE) or HandleUserLoginRequest (FALSE), the result of which is that either the user is logged in or the system is put back into status 55 in which the login for another user is waiting.

If the system is in such a waiting status 55 and the login is waiting for another user, step 57 then defines whether the application program agrees to logging a new user in or not. If not, then a message is generated to the user interface dialog 58 informing the new user that the login procedure has failed. Depending on the user's entry, the user interface is removed in step 41 to prevent viewing of the temporary application data. Following in step 41 which is also called the screen lock, the system, depending on the previous steps, is either found in the status with user 1 logged in or in status 55 with the login waiting for another user.

An alternative to this is to use the ability in the user interface dialog 58 to log another user into the system without the confirmation from the application program in previous step 57 which is known as a “Forced Log In.” This possibility can be required, e.g., in medical emergencies. Depending on the Forced Log In or upon confirmation from the application program in step 57, the system is found in status 59 in which the login procedure for another user is performed. In step 60, a check is run to determine whether this login has been performed within the defined time limit.

If not, the screen is cleared in step 41. If another user could login within the defined time period, then user 2 is logged in after step 60 which is shown in FIG. 5 with User 2 logged in 108.

Assuming that user 2 is logged into the system, the user can be asked to log out with user interface dialog 61. The system is then found in status 56, in which the login for the user is held. The user logout is then performed and the system is again found in the status with no user logged in and is shown in FIG. 5 as User Logged Out 104.

From this status or using the user interface dialog Request Shutdown, the system can be shutdown to the end condition 54.

FIG. 5, as so described, is a good example of the states and procedures which occur if user 1 is logged into the system, and then a switch to user 2 who then logs out of the system occurs. The procedures and ramifications shown here by no means represent the full functionality that the system offers, but simply show an example of processing. The most important thing about the procedures is that logging in and out and switching users can be done without having to end or start any application programs or the operating system.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for logging a new user into a data processing device with an operating system and an application program, comprising the sequential steps of:
in a first step, determining authentication data for authenticating a user;
defining an identity and access rights depending on the authentication data; and
providing access, depending on the defined access rights, for at least one of the application program and sensitive data;
the method being independent of restarting the operating system or the application program.

2. The method according to claim 1, further comprising:
displaying a user interface, depending on the defined access rights;
performing a user switch process step that causes the method to begin again at the first step, content of a user interface remaining unchanged until access rights have been defined again.

3. The method according to claim 2, wherein the content of the user interface is reduced if the renewed definition of access rights defines a more limited scope than the previous definition allowed.

4. The method according to claim 3, further comprising:
generating a warning message indicating a reduction in content and that the user has an opportunity to begin the method at the first step again before the reduction.

5. The method according to claim 1, further comprising:
displaying a user interface in accordance with the access rights that are defined;
deleting, by a User Logout procedure, content of a user interface; and
starting the method from the first step again.

6. The method according to claim 1, further comprising:
logging all access to the application program and all access to the sensitive data together with the respectively defined identity.

7. The method according to claim 1, further comprising:
activating a screen saver by a defined condition to make a user interface illegible; and
beginning the method from the first step again.

8. The method according to claim 7, wherein the defined condition is some amount of elapsed time.

9. The method according to claim 1, further comprising:
blocking all access rights based upon a failed attempt to authenticate a user in the first step.

10. A computer program that is configured to run on a data processing device to run the method according to claim 1.

11. A data storage media having a program is stored upon it which can work with a data processing device to run the method according to claim 1.
